(19) United States
(12) Patent Application Publication
(10) Pub. No.: US 2022/0002089 A1
(43) Pub. Date: Jan. 6, 2022

(54) Device for holding a product, and unit for conveying products

(71) Applicant: SIDEL PACKING SOLUTIONS SAS, CORCELLES-LES-CITEAUX (FR)

(72) Inventors: Michel BEGIN, Corcelles-les-Citeaux (FR); Jérémy DUPONT, Corcelles-les-Citeaux (FR); Vincent RODOT, CORCELLES-LES-CITEAUX (FR); Jean-Claude WAELDIN, REICHSTETT (FR)

(21) Appl. No.: 17/291,702

(22) PCT Filed: Nov. 7, 2019
(86) PCT No.: PCT/EP2019/080578

§ 371 Date: May 6, 2021

(30) Foreign Application Priority Data
Nov. 7, 2018 (FR) 1860247

(51) Int. Cl. B65G 17/32; B65G 54/02

(52) U.S. Cl. CPC B65G 17/323; B65G 2201/0261; B65G 2207/08; B65G 54/02

(57) ABSTRACT

The present invention relates to a retention device for a product which is compatible with a plurality of different shapes of products, within an industrial line for producing and processing products, comprising a frame with a receiving base which is intended to support the bottom of a product; a gripping means for a product comprising a set of pincers which is provided with two jaws which can be moved between a spaced-apart position and a closed-up position. Each jaw is mounted freely in terms of rotation about a pivot point and has a concave vertical shape in order to retain the product at least at one upper support location and at least at one lower support location. The invention also relates to a conveying installation for products within an industrial line for producing and processing products, comprising at least one retention device according to the invention.

The present invention relates to the field of conveying products within an industrial line for producing and processing the products.

Within the present invention, the term “product” covers an individual object. Such a product is a receptacle, such as a bottle, in particular of plastics material, which may be rigid or semi-rigid. Such a receptacle is intended to contain a liquid or food products.

In the context of the invention, a product may have any type of shape, symmetrical or non-symmetrical, regular or irregular. Preferably, a product has a specific shape which has an asymmetry, a non-regular cross section, or a non-planar bottom or base. In this manner, in particular a product may therefore have a base or a cross-section which is circular, elliptical or oval, polygonal, in particular parallelepipedal, or complex. Such products may also have planar or curved walls which are straight or curved. They may have a height which is orthogonal or inclined relative to at least one of their bases, generally forming cylinders, cones or truncated cones, even truncated spheres.

Preferably, but in a non-limiting manner, such products with a specific shape may be bottles which are intended for the agri-food sector, personal care and cosmetic products (or FHPC “Food, Home/Health and Personal Care”).

In known manner, within an industrial line, the products may receive several different successive processing operations, ranging from production of the container using a plastics material injection-molding operation or stretch blow-molding operation to packaging in batches of several grouped products, including filling and labeling of the products by the unit.

The invention relates to conveying products by the unit with a view to them being processed successively one by one. In a non-limiting manner, such a processing operation may, for example, be the filling of the product, the closure thereof with a stopper or the labelling thereof.

In this context, the products as a result of their specific shape cannot be transported directly on the surface of standard conveyors, for example, of the continuous belt type. This is because, for example, in the case of a bottle which has a curved base, there is no stability on a planar surface.

Furthermore, the asymmetry of the specific shape of such products requires them to be orientated specifically at the time of specific processing operations, such as, for example, the labelling which has to be carried out at a precise location of the bottle, in particular in the region of the front and rear faces thereof. The same applies during the packaging, for example, in boxes, where the products are orientated beforehand in order to optimize the filling of the boxes.

One existing solution involves depositing each product within a receptacle within which there is provided a housing which is shaped to complement the specific shape of the product, in particular at the lower portion thereof. Such a receptacle has a planar base which allows it to be deposited on the surface of a conventional conveyor, in particular with a continuous belt. Such a receptacle is generally referred to as a bucket or a “puck”.

A first disadvantage involves the shape of a puck which is dedicated to a specific product format. During a production change, it is necessary to replace all the pucks of the products which have previously been produced with new pucks which are shaped to receive the new products to be processed. Such an operation involves a significant loss of time. Furthermore, the storage space required for the pucks which are not used, and the problems of referencing in order to find them at the time of the production change, can be readily understood. Furthermore, in accordance with the number of formats to be processed, the purchase and replacement cost of each type of puck per format is great.

An interchangeable shell which fits inside a base has thus been envisaged. An example of such a shell is described in document WO 2017/157689. If such a shell has dimensions which reduce the storage space, it always involves replacing them at the time of a production change, but also fixing them to the bases which is a long and complex operation.

Currently, there is therefore a real problem of conveying in an optimized manner several products of a specific shape and with different formats along a production line, whilst ensuring that they are retained and orientated with regard to their various processing operations. Overall, the same conveying installation must be able to receive several products of different shapes and adapt to these various formats.

To this end, an object of the invention is to overcome the disadvantages of the prior art by providing a retention device for a product which is capable of adapting to various product formats and shapes.

Furthermore, the device according to the invention ensures complete retention by adapting to products of different formats and shapes, whilst ensuring their referencing and their orientation. This retention also leaves freely accessible the zones and portions of the products required for their processing operations, such as the spout for filling and closure using a stopper, or the front and rear walls for the labelling.

To this end, the invention relates to a retention device for a product which is compatible with a plurality of different shapes of products within an industrial line for producing and processing products, comprising:
a frame with a receiving base which is intended to support the bottom of a product;
a gripping means for a product comprising a set of pincers which is provided with two jaws which can be moved between a spaced-apart position and a closed-up position.

Such a device is characterized in that each jaw is mounted freely in terms of rotation about a pivot point and has a concave vertical shape in order to retain the product at least at one upper support location and at least at one lower support location.

In an additional but by no means limiting manner, each jaw may have a recessed horizontal shape at least at the upper portion and at the lower portion in order to retain the product at one side and the other in at least two upper support locations and in at least two lower support locations.

The retention device may comprise resilient return means for each jaw from the spaced-apart position to the closed-up position.

The base can be movably mounted in terms of rotation relative to the frame.

The base may be able to be vertically adjusted relative to the frame.

The base may have a curved receiving surface.

The base may be at least partially covered by a slip-resistant coating.

Each jaw may comprise a slip-resistant coating at least at the levels of at least one of the upper and lower support locations.

Each jaw may comprise a shape-memory coating at least at the levels of at least one of the upper and lower support locations.

The invention also relates to a conveying installation for products within an industrial line for producing and processing products, comprising at least one retention device as described above.

Additionally, but by no means in a limiting manner, such an installation may comprise at least one conveying means for at least one retention device.

The conveying means may comprise a motorization of each retention device in the form of at least one linear motor.

Other features and advantages of the invention will be appreciated from the following detailed description of the non-limiting embodiments of the invention, with reference to the appended Figures, in which:

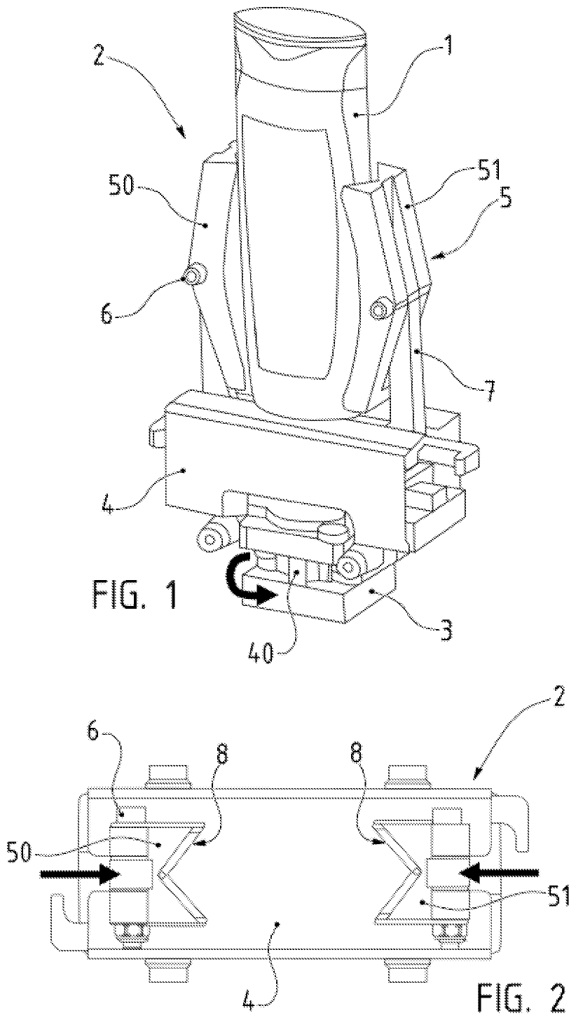

FIG. 1 is a schematic, perspective view of an example of a retention device, within which a product of the bottle type with a specific shape is positioned and retained;

FIG. 2 is a schematic plan view of a retention device, without any product;

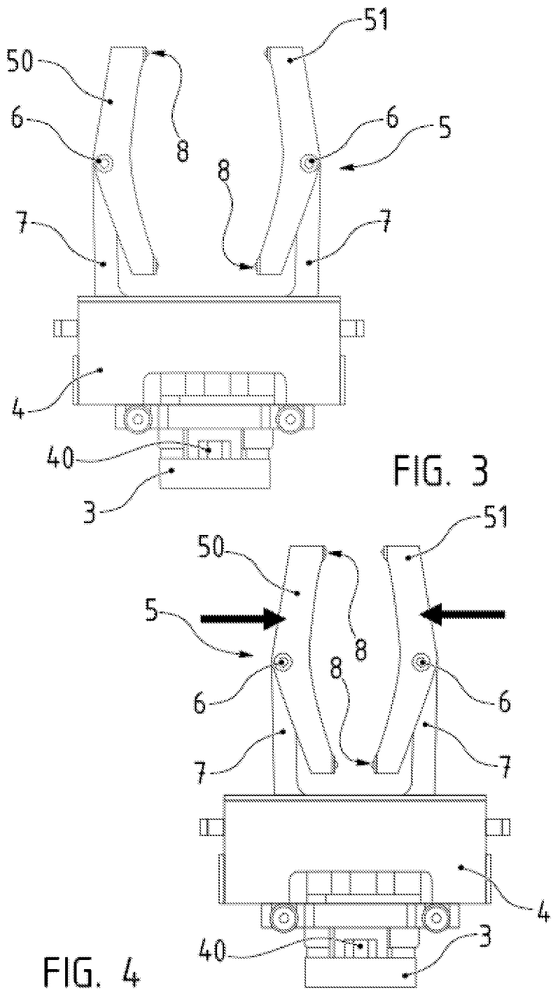

FIG. 3 is a schematic front view of a retention device, with the set of pincers thereof in the open position; and

FIG. 4 is a schematic view similar to FIG. 3, in a closed position of the set of pincers.

The present invention relates to conveying products 1 and retention products 1 when they are conveyed within an industrial line for producing and processing products 1.

A product 1 is an individual object, such as a receptacle, for example, a bottle, in particular of rigid or semi-rigid plastics material. Such a receptacle is intended to contain a liquid or food products. A product 1 may be of any type of form, symmetrical or non-symmetrical, regular or irregular. Preferably, a product has a specific shape which has an asymmetry, in particular since the shape does not result from a symmetry generated by revolution about a vertical or substantially vertical axis, a non-regular cross-section or a non-planar bottom or base. In this manner, in particular, a product 1 may therefore have a base or a cross-section which is circular, oblong, such as elliptical or oval (that is to say, longer rather than wide), polygonal, in particular parallelepipedal, or even complex. Such products 1 may also have planar or curved walls, which may be straight or curved, in particular rounded edges. They may have a height which is orthogonal or inclined relative to at least one of their bases, generally forming cylinders, cones or truncated cones, even truncated spheres.

An example of a product 1 is illustrated in FIG. 1 comprising a flattened specific shape which is generally cylindrical with an oval cross-section, such as a lozenge-like product, with a curved base and a flat top.

A product 1 is subjected to successive processing operations along the industrial line, which may range from the production of the container by means of a plastics material injection-molding operation or a stretch blow-molding operation up to packaging in batches of several grouped products, including the filling and labeling of the products by the unit. During these operations, each product 1 must be conveyed along and through the stations which are dedicated to its processing.

To this end, the invention relates to a conveying installation for products 1.

In the context of the present invention, the installation ensures the conveying of any type or formats of products 1, in particular products 1 which have a specific shape, as described above.

Such an installation may be located at least between two processing stations for products 1. It may also pass through and/or connect one or more stations. Within the same industrial line, several installations may be positioned between and each one passing through one or more stations.

Furthermore, the installation may enable correct positioning and/or correct orientation of the products 1 when they are conveyed and/or during each of their different processing operations.

To this end, the installation comprises at least one retention device 2 for a product 1. Preferably, the installation comprises several devices 2 which each enable it to be ensured that a product 1 is retained during its conveying and/or one of the processing operations thereof.

To this end, the installation may comprise at least one conveying means for at least one device 2. Such a conveying means may be in the form of a conveyor, in particular of the continuous belt type, which receives at the surface one or more devices 2, in a removable manner, in a fixed or non-fixed manner. Such a conveying means may also comprise at least one belt or chain which cooperates with each device 2 and which ensures the movement thereof.

Preferably, the conveying means may comprise a motorization of each retention device 2 in the form of at least one linear motor. In this manner, each device 2 may be mounted on a shuttle and this type of motorization enables independent movements to be ensured for each shuttle and thus each device 2. Furthermore, the same shuttle can thus be displaced along several successive installations. Furthermore, the use of the linear motors for moving the retention devices 2 within an installation enables devices 2 to be referenced, that is to say, the position of each device 2 to be known at all times, and consequently each product 1 retained by each device 2.

As mentioned above, a device 2 must ensure that a product 1 is retained when it is conveyed along the installation.

Each device 2 in principle ensures that a single product 1 alone is retained at the same time.

In particular, the device 2 is provided to be compatible with different formats of products 1, which do not need to be replaced between two operations for producing products 1 which have different formats.

Furthermore, the device 2 is provided to be compatible with different forms of products 1, thus enabling a product 1 which is of regular shape but also of irregular or specific shape to be retained.

Furthermore, the device 2 enables a product 1 to be retained, leaving free specific portions of the external faces thereof, with a view to receiving a specific processing operation, such as, for example, labelling on the front and/or rear of the product 1, that is to say, generally referred to as being the front face and rear face of the product 1, respectively. In the example of FIG. 1, a device 2 retains a product 1 at one side and the other, along the ridges thereof, leaving free the largest front and rear faces.

The retention device 2 comprises a frame 3. The frame 3 supports the other elements of the device 2. It enables the cooperation with the conveying means for one or more installations, acting in particular as a shuttle in the case of driving by means of a linear motor.

The frame 3 comprises a receiving base 4 which is intended to support the base of a product 1. To this end, the base 4 has a receiving surface which may or may not be planar, horizontal or inclined. Preferably, the receiving surface of the base 4 may be curved, that is to say, it has an indentation which enables in particular a curved bottom of a product 1 to be received in a more adjusted manner. Such an indentation may comprise inclined lateral walls which generally form a truncated cone, ensuring the adjustment in terms of insertion of the bottom of a product 1 but also the peripheral walls thereof.

The base 4 may be covered at least partially with a slip-resistant coating, limiting the occurrences of sliding of the walls of the product 1 on contact therewith.

According to an embodiment, the base 4 is mounted so as to be able to be moved in terms of rotation relative to the frame 3. In other words, the upper portion of the device 2 which is intended to receive a product 1 can rotate in order to orientate the product 1 differently. One rotation example of the base 4 is illustrated in one direction in FIG. 1. Such a rotation of the base 4 is carried out in principle about an axis which extends vertically. Such an axis is mounted on the frame 3, substantially at the center thereof and preferably in alignment with the center of gravity of the retention device 2.

According to a preferred embodiment, the rotation can be carried out through an angle of 90°. In particular, it is possible to carry out several rotations, in particular through an angle of 90° in order to return to the initial position.

In particular, the rotation angle of the base 4 may be provided to be adjustable. Such an adjustment may be carried out manually by an operator, determining an angular position of each base 4 for each device 2. Preferably, the adjustment of the rotation may be provided to be controlled, in particular via a dedicated motorization or via a mechanical system which cooperates with a complementary mechanical system of the installation(s) along which the device 2 is conveyed.

Consequently, the device 2 will subject the products 1 to a rotation about the vertical axis, extending orthogonally relative to the upper face of the conveyor. Generally, when they are inserted inside a device 2, a product 1 is orientated with the length thereof which extends longitudinally, that is to say, along the conveying direction. After being turned to 90°, a product 1 is orientated transversely, the width thereof extending in the conveying direction (that is to say, the length thereof extending transversely or orthogonally to the conveying direction).

Furthermore, via the retention of each product 1 conferred by the device 2, the invention enables any instability or imbalance of the product 1 to be dispensed with, when the width thereof extends in the conveying direction, in particular when it is subjected to accelerations and decelerations.

In this manner, when each device 2 moves to a location and/or along a portion of an installation, the cooperation of the systems applies a rotation to each base 4 in accordance with an angle which has been provided and determined previously. It is thus possible to modify the orientation of a product 1 relative to the device 2 along the industrial line, which particularly enables the products 1 which are, for example, oblong, to be orientated with their length extending transversely relative to the conveying direction in order to be able to move several devices 2 closer to each other in order to transport more products over an identical conveying portion. It is also possible to position the products 1 with their length extending longitudinally relative to the conveying direction, in particular in order to enable intervention at the front and/or rear from one of the sides of the installation, or to rotate the products in order to position them correctly with a view to them being packed, or to rotate each product 1 when it moves within a processing station in order to carry out the specific processing operation.

Furthermore, the device 2 may comprise resilient return means which are applied to the base 4 in order to make it return to an initial angular position.

According to an embodiment, the base 4 can be adjusted vertically relative to the frame 3. Such an adjustment can be carried out manually by an operator, raising or lowering each base 4 of each device 2, but preferably in a controlled manner, in particular via a dedicated motorization or via a mechanical system which cooperates with a complementary mechanical system of the installation(s) along which the device 2 is conveyed. In this manner, when each device 2 moves to a location and/or along a portion of an installation, the cooperation of the systems can apply the raising or the lowering of the base 4 relative to the frame 3. It is thus possible to modify the vertical position of a product 1 relative to the device 2 along the industrial line. In particular, it is possible to vertically index the position of a product 1 with a given shape and to modify this indexed position for another shape, ensuring the referencing of the product 1 within the device 2. Overall, it is possible to adapt the vertical position of the base 4 in accordance with the size of the product 1 to be transported so that the processing operations can be carried out regardless of the height of the products 1.

Consequently, the products 1 are located with excellent positioning with regard to their retention by the devices 2 but can also be adjusted vertically with regard to the processing operations to which they are subjected.

By way of example, the device 2 may comprise a mechanical cam or gearing system 40 which enables the rotation and/or the vertical movement of the base 4 relative to the frame 3 to be ensured. Such a cam 4 may be activated in contact with complementary elements with which the installation(s) is/are provided, such as a member which protrudes relative to the path of the device 2 and which comes into contact with the cam 40 in order to make it rotate and/or rise in accordance with an indexed position.

Furthermore, the device 2 comprises a gripping means 5 for a product 1. The gripping means 5 comprises a set of pincers which is provided with two jaws 50, 51. The jaws 50, 51 can be moved between a spaced-apart position and a closed-up position. In the spaced-apart position, the jaws 50, 51 open in order to allow sufficient space to remove or introduce a product 1 between the set of pincers, with or without play between the inner surfaces of the jaws 50, 51 and the peripheral walls of the product 1. In a closed-up position, the jaws 50, 51 close until they clamp a product 1. In an empty state, without any product 1, the jaws 50, 51 may move into abutment with each other or be spaced apart relative to each other.

Such a mobility can be carried out symmetrically or non-symmetrically relative to a vertical plane, in particular the vertical center plane of the device 2.

According to another specific configuration, only one of the jaws 50 (or 51) is provided to be movable relative to the base 4, the other 51 (or 50) being fixed.

According to an embodiment, the device 2 may comprise means for resilient return of each jaw 50, 51 from the spaced-apart position to the closed-up position. This resilient return automatically applies a pressure at one side and the other of a product 1, ensuring that it is retained in opposition, as if it were gripped from both sides. The force applied may be able to be adjusted manually or in a controlled manner by modifying the resilience of the return means.

The mobility of the jaws 50, 51 enables the distance between the jaws 50, 51 to be adapted and the gripping to be applied to a product 1, in accordance with the shape thereof, but also other characteristics, such as the rigidity thereof.

Advantageously, the device 2 can be adapted to different shapes of products 1, including specific shapes.

To this end, each jaw 50, 51 is mounted so as to be able to rotate freely about a pivot point 6, enabling each jaw 50, 51 to tilt and to ensure that it comes into contact with the walls of the product 1 to be gripped, even if the walls are not straight or vertical. This is because, about each pivot point 6, each jaw 50, 51 can rotate through an angle which is sufficient to be inclined in accordance with the slope of the wall of the product 1 located opposite each jaw 50, 51.

According to a preferred embodiment, each pivot point 6 receives an axis which extends horizontally or substantially horizontally, the axes of the pivot points 6 of the jaws 50, 51 being parallel, preferably in the same horizontal plane. Each jaw 50, 51 rotates about the axis thereof which is centered relative to each pivot point 6.

Each jaw 50, 51 has a vertical, concave shape in order to retain the product 1 at least at one upper support location and at least at one lower support location. In this manner, each jaw 50, 51 comes into contact at the upper portion and at the lower portion of the product 1, which is then gripped at one side and the other at least at four locations.

Furthermore, the concave shape of the jaws 50, 51 extends from the opposing inner side. Overall, relative to a vertical or substantially vertical plane, the upper and lower portions of each jaw 50, 51 are offset toward the inner side of the set of pincers, relative to the center of each jaw 50, 51. This concave shape may be rounded or constituted by segments.

The device 2 may comprise arms 7 which support the jaws 50, 51. Each arm 7 extends vertically or in a substantially vertical manner. In particular, the distal upper end of each arm 7 receives the pivot point 6 of each jaw 50, 51, in particular the axis which is mounted freely in terms of rotation relative to each arm 7 and/or relative to the corresponding jaw 50, 51. In the lower portion, each arm 7 may be mounted to be movable on the base 4 or the frame 3. Each arm 7 may be provided to be movable in terms of translation, rotation or a combination of both. Consequently, the arms 7 are the members which are movably mounted for movement toward the inner side or toward the outer side of the device 2 in order to cause the jaws 50, 51 to move together or apart.

Furthermore, the activation in terms of moving the jaws 50, 51 together or apart may be controlled mechanically by an adapted system during movement from a location or along a portion of one or more installation(s). The spacing of the jaws 50, 51 may also be carried out by introducing a product 1, pushing with force, and conversely during removal by pulling the product 1 until it is released from the device 2, the jaws 50, 51 moving together under the action of resilient return. Consequently, the opening or the closing of the jaws 50, 51 does not involve any manual intervention of an operator on each device 2.

Furthermore, the tilting of the jaws 50, 51 about the pivot point 6, combined with this recessed shape, ensures that they come into contact along the four support locations, regardless of the vertical nature of the walls of the product 1 to be retained.

Each upper support location is located above the pivot point 6, whilst each lower support location is located below. Preferably, each upper support location may be located above the center of gravity of the product 1, whilst each lower support location is located below the center of gravity. Depending on the product 1, the shape and the characteristics thereof, in particular the mass thereof, it is thus possible to modify the location of the center of gravity thereof, in particular via the vertical movement of the base 4, the jaws 50, 51 being able to be mounted on the frame 3.

Preferably, the retention by means of gripping with the set of pincers may be carried out in the direction of the greatest length of the base of the product 1. In summary, each jaw 50, 51 moves into abutment, at one side and the other, with each edge of the length of the product 1. Furthermore, in the case of a product 1 with a base having a regular shape, such as a disk or a polygon, the gripping thereof can be carried out in accordance with the diameter or the diagonal. In the case of an irregular shape, the product 1 can be gripped along the largest diagonal or the largest internal dimension. It is also possible to grip the products 1 in another manner, along the diameter thereof, the side thereof or the smallest diagonal thereof.

According to an embodiment, each jaw 50, 51 may have a horizontal recessed shape at least in the upper portion and in the lower portion in order to retain the product 1 at one side and the other at least at two upper support locations and at least at two lower support locations. Overall, each jaw 50, 51 surrounds the product 1 at one side and the other relative to a vertical plane, ensuring at the top and at the bottom a support on the front and rear faces thereof (i.e. at the front and the back). The recess of the jaws 50, 51 may be rounded or in the form of segments. It is provided in the inner face of each jaw 50, 51, in a state recessed toward the interior. As can be seen in the Figures, in particular FIG. 2, the jaws 50, 51 may have a recess which is V-shaped.

In this manner, the product can be gripped laterally and transversely, improving the retention thereof within the device 2. The tilting combined with the recesses of the jaws 50, 51 enables the gripping type retention to be adapted to very varied shapes, in particular clamping quite specific shapes, such as, for example, with an oval or elliptical base, and the ridges of polygons, but also protruding or even rounded edges, such as, for example, a cross-section of the lozenge-like type.

Furthermore, it will be readily understood that each at least one upper support location and lower support location of each jaw 50, 51 may constitute a support surface at a plurality of support locations in accordance with the shape of the product 1 at these support levels and in accordance with the conformity of each jaw 50, 51.

In order to improve the engagement of the retention of the set of pincers, each jaw 50, 51 may comprise a slip-resistant coating 8 at least at the levels of at least one of the upper and lower support locations. Such a coating may be constituted by a flexible or resilient material, such as a synthetic or natural rubber. This coating is applied to the inner face of the jaws 50, 51. It may protrude internally, in particular being in the form of bars 8 of slip-resistant material, as can be seen in FIGS. 2 to 4.

According to an embodiment, each jaw 50, 51 may comprise a shape-memory coating at least at the levels of at least one of the upper and lower support locations. Preferably, the entire surface of each jaw 50, 51 is covered with a shape-memory material. Such a material has a resilience which enables it to become deformed in contact with the walls of a product 1 at the time of the gripping thereof. The resilience of this material enables the imprint of a product 1 to be retained for a specific period of time, even after it has been removed from the device 2. Furthermore, the delay in this material returning to its original form may be provided over a duration which corresponds to the time required for a production change to a different format of product 1, for example, from a few seconds to a few minutes.

Generally, and as can be seen from the above, the device 2 is a retention device for a single product 1. In this manner, the products 1 are conveyed individually within a conveying installation and the distance and/or the arrangement between the successive products 1 can be readily modified in accordance with the processing operations to be carried out on the products 1.

As can also be seen from the above, the set of pincers may comprise precisely two jaws 50, 51 which can be moved between a spaced-apart position and a gripped position in order to be able to retain or release a product 1 as required. In principle, the two jaws 50, 51 of the set of pincers are opposite each other.

In this manner, the device 2 is in principle a retention device 2 for a single product 1 comprising a set of pincers which is provided with precisely two jaws 50, 51.

According to a preferred embodiment, the mobility between the two jaws 50, 51 for opening or closing the set of pincers is carried out in accordance with a horizontal translation movement. In this manner, at least one jaw 50, 51 may be mounted freely in terms of translation relative to the base 4 in a horizontal plane in the direction of the other jaw 50, 51. Preferably, the two jaws can move together and away from each other using respective horizontal translation movements.

To this end, at least one of the jaws 50, 51 may be fixed to the base 4 via at least one horizontal sliding member which is directed from one jaw 50, 51 to the other. Preferably, the two jaws 50, 51 are mounted in this manner.

In particular, when the jaws 50, 51 are supported by arms 7, these arms may be fixed to the base 4 using at least one such sliding member.

In this manner, according to this embodiment, the device 2 is particularly suitable for being able to retain products 1 of very different widths. This is because, regardless of the width of the product 1 to be retained, the jaws 50, 51 will be close to each other to a greater or lesser degree, but always at the same height. Consequently, even for products 1 of very different widths, the at least one upper support location and the at least one lower support location may be located above and below the center of gravity of these products 1, respectively, when they are retained by such a device 2, which thus ensures optimum retention.

This is particularly advantageous in so far as the different products of the same range often have heights substantially of the same order, but widths which are very heterogenous. In other words, within the same industrial line, the various formats of products 1 processed have heights which are similar to each other and varied widths.

In this manner, in preferred embodiments, the device 2 is a retention device 2 for a single product 1 which is compatible with a plurality of different shapes of products 1 within an industrial line for producing and processing products 1, comprising:
a frame 3 with a receiving base 4 which is intended to support the base of a product 1;
a gripping means 5 for a product 1 comprising a set of pincers which is provided with precisely two jaws 50, 51 which can be moved between a spaced-apart position and a closed-up position;

the device 2 is characterized in that:
each jaw 50, 51 is mounted freely in terms of rotation about a pivot point 6 and has a concave vertical shape in order to retain the product 1 at least at one upper support location and at least at one lower support location, and
at least one of the two jaws 50, 51 is movably mounted in terms of translation relative to the base 4 in a horizontal plane in order to enable the movement between the spaced-apart position and the closed-up position.

In this manner, the device ensures improved retention of a product 1 by adapting to several formats and several shapes, even specific and complex shapes.

1. A retention device (2) for a product (1) which is compatible with a plurality of different shapes of products (1), within an industrial line for producing and processing products (1), comprising:
a frame (3) with a receiving base (4) which is intended to support the bottom of a product (1);
a gripping means (5) for a product (1) comprising a set of pincers which is provided with two jaws (50, 51) which can be moved between a spaced-apart position and a closed-up position;
wherein:
each jaw (50, 51) is mounted freely in terms of rotation about a pivot point (6) and has a concave vertical shape in order to retain the product (1) at least at one upper support location and at least at one lower support location.

2. The retention device (2) as claimed in claim 1, wherein each jaw (50, 51) has a recessed horizontal shape at least at the upper portion and at the lower portion in order to retain the product (1) at one side and the other in at least two upper support locations and in at least two lower support locations.

3. The retention device (2) as claimed in claim 1, further comprising a resilient return means for each jaw (50, 51) from the spaced-apart position to the closed-up position.

4. The retention device (2) as claimed in claim 1, wherein the base (4) is movably mounted in terms of rotation relative to the frame (3).

5. The retention device (2) as claimed in claim 1, wherein the base (4) can be vertically adjusted relative to the frame (3).

6. The retention device (2) as claimed in claim 1, wherein the base (4) has a curved receiving surface.

7. The retention device (2) as claimed in claim 1, wherein the base (4) is at least partially covered with a slip-resistant coating.

8. The retention device (2) as claimed in claim 1, wherein each jaw (50, 51) comprises a slip-resistant coating (8) at least at the levels of at least one of the upper and lower support locations.

9. The retention device (2) as claimed in claim 1, wherein each jaw (50, 51) comprises a shape-memory coating at least at the levels of at least one of the upper and lower support locations.

10. A conveying installation for products within an industrial line for producing and processing products (1), comprising at least one retention device (2) as claimed in claim 1.

11. The conveying installation as claimed in claim 10, further comprising at least one conveying means for at least one retention device (2).

12. The conveying installation as claimed in claim 11, wherein the conveying means comprises a motorization of each retention device (2) in the form of at least one linear motor.

13. The retention device (2) as claimed in claim 2, further comprising a resilient return means for each jaw (50, 51) from the spaced-apart position to the closed-up position.

14. The retention device (2) as claimed in claim 2, wherein the base (4) is movably mounted in terms of rotation relative to the frame (3).

15. The retention device (2) as claimed in claim 2, wherein the base (4) can be vertically adjusted relative to the frame (3).

16. The retention device (2) as claimed in claim 2, wherein the base (4) has a curved receiving surface.

17. The retention device (2) as claimed in claim 2, wherein the base (4) is at least partially covered with a slip-resistant coating.

18. The retention device (2) as claimed in claim 2, wherein each jaw (50, 51) comprises a slip-resistant coating (8) at least at the levels of at least one of the upper and lower support locations.

19. The retention device (2) as claimed in claim 2, wherein each jaw (50, 51) comprises a shape-memory coating at least at the levels of at least one of the upper and lower support locations.
